(19) United States
(12) Patent Application Publication
(10) Pub. No.: US 2009/0253409 A1
(43) Pub. Date: Oct. 8, 2009

(54) Method of Authenticating Home Operator for Over-the-Air Provisioning of a Wireless Device

(75) Inventors: Kristian Slavov, Espoo (FI); Patrik Mikael Salmela, Kirkkonummi (FI)

Correspondence Address: COATS & BENNETT, PLLC, 1400 Crescent Green, Suite 300, Cary, NC, 27518, US

(73) Assignee: Telefonaktiebolaget LM Ericsson (publ), Stockholm (SE)

(21) Appl. No.: 12/193,165

(22) Filed: Aug. 18, 2008

Related U.S. Application Data
(60) Provisional application No. 61/042,901, filed on Apr. 7, 2008.

(51) Int. Cl. H04M 1/66; H04Q 7/20

(52) U.S. Cl. 455/411; 455/435.1

(57) ABSTRACT

A method and apparatus is provided for authentication between a home network and a wireless device during device activation using a registration server as a trusted agent. The wireless device owner subscribes to the services of the home network and the home network registers as the service provider with the registration server. When the home network registers with the registration server, the registration server provides authentication data to the home network to use for authentication with the wireless device. Because the wireless device has no prior knowledge of the home network, the wireless device connects to the registration server to obtain contact information for the home network. The registration server provides home network data to the wireless device. In some embodiments, the registration server may also provide second authentication data to the wireless device for authenticating the home network. When the wireless device subsequently connects to the home network to download permanent security credentials, the home network uses the information provided by the registration server to authenticate itself to the wireless device. The authentication procedure prevents a third party from fraudulently obtaining confidential information from the home network or the wireless device.

### RELATED APPLICATION

This application claims priority under 35 U.S.C. §119(e) to U.S. provisional application Ser. No., 61/042,901 filed Apr. 7, 2008 and titled “Methods for providing authentication material using third party in M2M environment,” the entire contents of which are incorporated herein by reference.

### TECHNICAL FIELD

The present invention relates generally to wireless communication systems, and in particular relates to methods, apparatus, and systems for accessing a data server in a wireless network using information transferred during a network access authentication procedure.

### BACKGROUND

Machine-to-machine (M2M) communications technologies allow the deployment of wireless devices that do not require human interaction to operate. Wireless M2M devices have been deployed or proposed for a wide range of telemetry and telematics applications. Some of these applications include utility distribution system monitoring, remote vending, security systems, and fleet management.

One of the challenges for wireless M2M deployment is facilitating efficient “provisioning” of services. In particular, each wireless M2M device must be activated for operation in a particular network. With conventional 3G cellular telephones, provisioning is typically accomplished using a Universal Subscriber Identity Module (USIM), an application installed on a Universal Integrated Circuit Card (UICC) provided by the wireless network operator. The USIM/UICC may be inserted into a cellular handset to link the handset to a particular subscription, thus allowing the handset user to access subscribed services through his home operator's network and, in many cases, through cooperating partner networks. Although reasonably convenient for individual consumers, this approach to provisioning may be impractical for an M2M application where a single entity may deploy hundreds of wireless devices across a large geographical area. For instance, in some cases a wireless device may be factory installed in a larger piece of equipment (e.g., an automobile), making later insertion of a SIM card or UICC impractical or impossible. In other instances, M2M devices may be deployed over a wide geographical area, such that no single wireless operator can provide the needed coverage. In such cases, matching the proper operator-specific USIMs to the correct devices can be problematic. Finally, re-configuring the M2M device, e.g., to transfer the device to a subscription with a different operator, can be expensive, especially when the M2M device is in a remote location.

Because of these challenges, the wireless industry has recently been investigating the possibility of downloadable subscription credentials, e.g., a downloadable USIM (or DLUSIM). In particular, the 3^{rd}-Generation Partnership Project (3GPP) has been studying the feasibility of using DLUSIM technology for remote management of wireless M2M devices. A 3GPP report titled “Technical Specification Group Services and System Aspects; Feasibility Study on Remote Management of USIM Application on M2M Equipment; (Release 8), 3GPP TR 33.812, is currently under development.

In one approach under study, preliminary subscription credentials, e.g., a Preliminary International Mobile Subscriber Identity (PIMSI) and a preliminary key K, are pre-programmed into each wireless M2M device. The PIMSI and preliminary key K may be used to gain initial access to an available wireless network for the limited purpose of downloading “permanent” subscription credentials, such as a downloadable USIM. The PIMSI is associated with a registration service, which facilitates temporary access to a 3GPP network and connection to a provisioning server associated with a wireless operator offering the desired services.

The general approach is that a wireless M2M device uses the PIMSI (and the key K) to perform an initial network attachment procedure to an available network, referred to herein as the initial connectivity network, according to conventional wireless network protocols. The network to which the device connects may be assumed to be a visited network, so that the connection is made according to roaming procedures. Once connected to the network, the M2M device establishes a connection with a provisioning server of the selected home network for downloading a USIM.

Techniques for downloading a USIM are described in related U.S. patent application Ser. No. 12/135,256 filed 9 Jun. 2008 and U.S. patent application Ser. No. 12/139,773 filed 16 Jun. 2008 to applicants. Thus, a mechanism for linking a deployed wireless M2M device to a subscription for mobile network services from a wireless operator is needed. Although the above procedure permits an initial connection to a 3GPP network, it does not provide a complete solution for provisioning wireless M2M devices. For example, no mechanism is specified for authentication between the home network and wireless M2M device when the M2M device initially attaches to the home network to download a USIM. Without authentication, a fraudulent third party could pretend to be the home network to obtain confidential information from the wireless device. Also, the home network wants to be assured that the wireless device is in fact the subscriber's wireless device and not a fraudulent third party attempting to steal the services of the home network. Accordingly, new techniques are needed for authentication between a home network and wireless M2M device during device activation.

### SUMMARY

The present invention provides a method and apparatus for authentication between the home network and the wireless device during device activation using the registration server as a trusted agent. The wireless device owner subscribes to the services of the home network and the home network registers as the service provider with the registration server. When the home network registers with the registration server, the registration server 50 provides authentication data to the home network to use for authentication with the wireless device. Because the wireless device has no prior knowledge of the home network, the wireless device connects to the registration server to obtain contact information for the home network. The registration server provides home network data to the wireless device. In some embodiments, the registration server may also provide authentication data to the wireless device for authenticating the home network. When the wireless device subsequently connects to the home network to download permanent security credentials, the home network uses the information provided by the registration server to authenticate itself to the wireless device. The authentication procedure prevents a third party from fraudulently obtaining confidential information from the home network or the wireless device.

### BRIEF DESCRIPTION OF THE DRAWINGS

FIG. 1 illustrates an exemplary communication network according to one embodiment of the present invention.

FIG. 2 illustrates an exemplary device activation procedure.

FIG. 3 illustrates a first exemplary authentication procedure between the home network and wireless device using a registration server as a trusted agent.

FIG. 4 illustrates a second exemplary authentication procedure between the home network and wireless device using a registration server as a trusted agent.

FIG. 5 illustrates a third exemplary authentication procedure between the home network and wireless device using a registration server as a trusted agent.

FIG. 6 illustrates a fourth exemplary authentication procedure between the home network and wireless device using a registration server as a trusted agent.

FIG. 7 illustrates an exemplary registration server.

FIG. 8 illustrates an exemplary method performed by a registration server.

FIG. 9 illustrates an exemplary subscription and provisioning server.

FIG. 10 illustrates an exemplary method performed by a subscription and provisioning server.

FIG. 11 illustrates an exemplary wireless device.

FIG. 12 illustrates an exemplary method performed by a wireless device.

### DETAILED DESCRIPTION

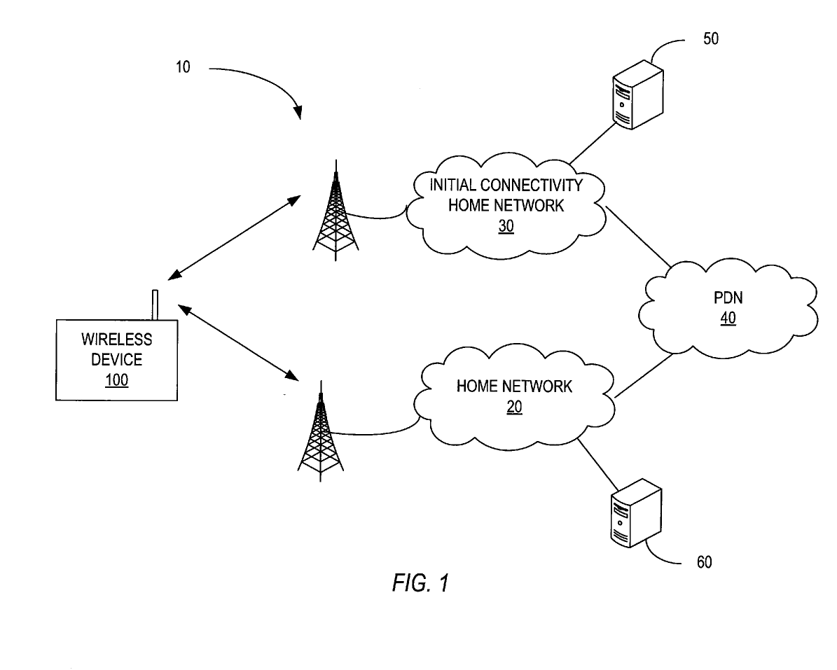

Referring now to the drawings, the present invention will be described in the context of an exemplary communication network 10 illustrated in FIG. 1. Those skilled in the art will appreciate that the illustrated network 10 represent only one possible network architecture and that the present invention is also useful with other network architectures. Communication network 10 comprises a home network 20 to which a wireless device 100 is subscribed, and an initial connectivity home network (ICHN) 30. The home network 20 and ICHN 30 both provide connection to an external packet data network (PDN) 40, such as the Internet.

The wireless device 100 may, for example, comprise an M2M device, cellular phone, or other wireless device. Wireless device 100 is pre-provisioned with a temporary device identifier that is used by the wireless device 100 to access the initial connectivity home network 20 prior to device activation. In one exemplary embodiment, the temporary device identifier comprises a Preliminary International Mobile Subscriber Identity (PIMSI). The wireless device 100 may also be provisioned with a preliminary key K.

The home network 20 may include a subscription and provisioning server 60 for subscribing and provisioning wireless devices 100. In some embodiments, the subscription and provisioning server 60 may alternatively be connected to the PDN 40. The subscription and provisioning server 60 may provide a web interface that allows wireless device owners to subscribe to the services of the home network 20 after purchase of the wireless devices 100. In other embodiments, subscription and provisioning server 60 may communicate with remote terminals controlled by sellers of the wireless devices 100 to enable the sellers to subscribe wireless devices 100 at the time of purchase. As will be described below, the subscription and provisioning server 60 is also responsible for provisioning wireless devices 100 with permanent security credentials during device activation. For example, the subscription and provisioning server 60 may provide wireless devices 100 with Downloadable Universal Subscriber Identity Modules (DLUSIMs).

A registration server 50 connects to the PDN 40 and may be accessed through both the home network 20 and the ICHN 30. Registration server 50 may, alternatively be located in either the home network 20 or in the ICHN 30. As will be described in greater detail below, the registration server 50 facilitates device activation in the scenario where the device owner selects the home network 20 and the wireless device 100 is not preconfigured with information about the home network 20.

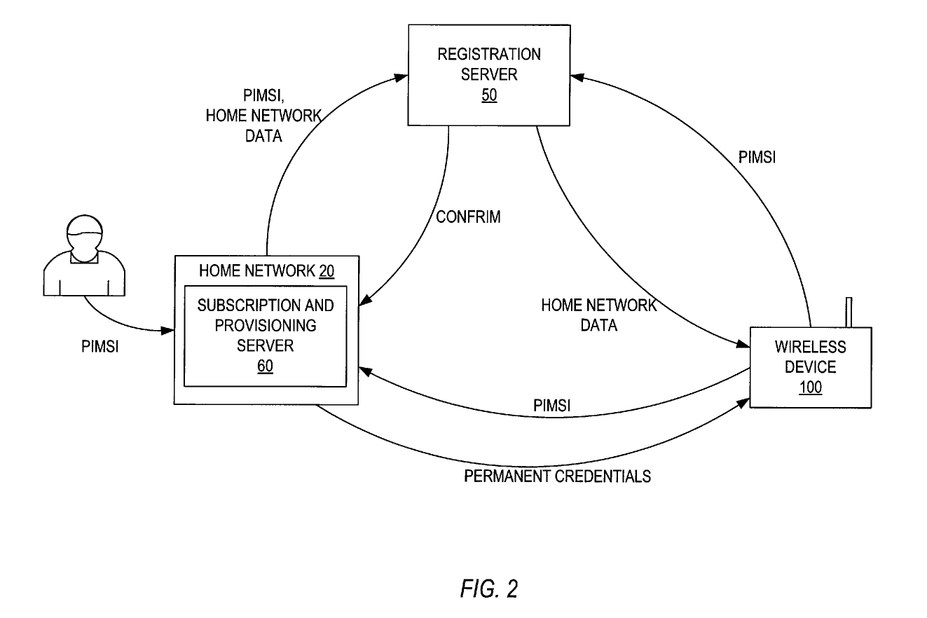

In order to activate the wireless device 100, the wireless device 100 connects to the registration server 50 to obtain information about the home network 20. The wireless device 100 subsequently connects to the home network 20 to download permanent security credentials from the home network 20. FIG. 2 illustrates an exemplary activation process. The activation process has four main phases: a subscription phase, a registration phase, an initial contact phase, and an activation phase. As noted above, the wireless device 100 is pre-provisioned by the device manufacturer with a temporary device identifier and preliminary key. During the subscription phase, the owner of the wireless device 100 subscribes to the services of the home network 20 and provides the selected home network operator with its temporary device identifier and preliminary key. During the registration phase, the home network 20 registers the subscription with the registration server 50 and provides home network data to the registration server 50. The home network data may comprise, for example, a network identifier and/or an IP address for connecting to the home network 20. The registration server 50 stores an association between the temporary device identifier and the home network 20. In the initial contact phase, the wireless device 100 uses its temporary device identifier to access the registration server 50 through the ICHN 30. The registration server 50 provides home network data to the wireless device 100. In the activation phase, the wireless device 100 uses the home network data to connect to the home network 20 to download permanent security credentials. The downloading of permanent security credentials completes the activation process and activates the wireless device 100 to access the home network 20.

A potential problem with the device activation procedure is the lack of authentication between the home network 20 and the wireless device 100 when the wireless device 100 connects to the home network 20 for the first time to download permanent security credentials. Without authentication, a fraudulent third party could pretend to be the home network 20 to obtain confidential information from the wireless device 100. Also, the home network 20 wants to be assured that the wireless device 100 is in fact the subscriber's wireless device 100 and not a fraudulent third party attempting to steal the services of the home network 20.

The present invention provides a method and apparatus for authentication between the home network 20 and the wireless device 100 during device activation using the registration server 50 as a trusted agent. The authentication procedure prevents a third party from fraudulently obtaining confidential information from the home network 20 or the wireless device 100. In the embodiments described below, the registration server 50 functions as a trusted agent. During the registration phase of the activation process, the registration server 50 provides authentication data to the home network 20 to use for authentication with the wireless device 100. When the wireless device 100 subsequently connects to the home network 20 to download permanent security credentials, the home network 20 uses the information provided by the registration server 50 to authenticate itself to the wireless device 100.

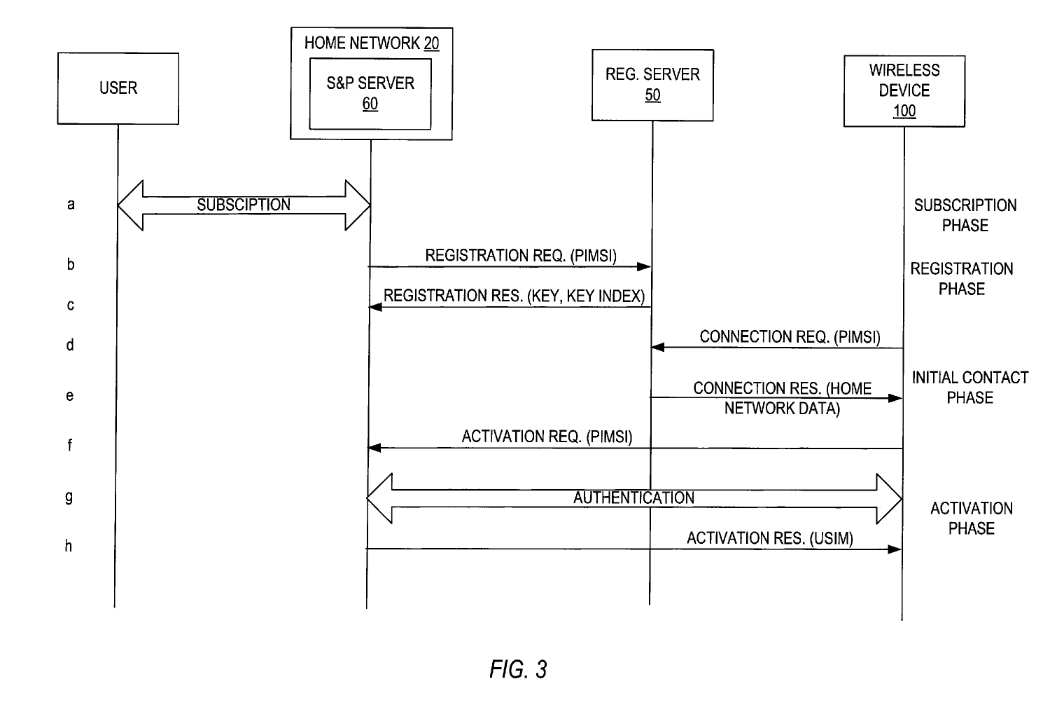

FIG. 3 illustrates an exemplary method for authentication between a home network 20 and a wireless device 100 according to one embodiment. A temporary device identifier and table of keys are loaded into the memory of the wireless device 100 during manufacture. The temporary device identifier may, for example, comprise a preliminary IMSI (PIMSI). The device manufacturer provides the table of keys and associated temporary device identifier to the registration server 50.

The device owner subscribes to services of the home network 20 (step a). During the subscription process, the user provides its temporary device identifier to the subscription and provisioning server 60 in the home network 20. The home network 20 then registers with the registration server 50 as the service provider for the wireless device 100 using the temporary device identifier provided by the wireless device owner. During the registration process, the home network 20 sends a registration request to the registration server 50 including the temporary device identifier for the wireless device 100 (step b). The registration server 50 uses the temporary device identifier to locate the corresponding key table and selects key index and corresponding key from the key table. The registration server 50 sends the selected key and corresponding key index to the home network 20 in a registration response message (step c). Known authentication procedures (not shown) may be invoked to assure that the registration server 50 does not send the keys to a fraudulent third party.

During the initial contact phase of the activation process, the wireless device 100 connects to the registration server 50 and receives the home network data from the registration server 50. The wireless device 100 sends a connection request including its temporary device identifier to the registration server 50 (step d). Registration server 50 uses the provided temporary device identifier to look up the home provider and sends the corresponding home network data to the wireless device 100 in a connection response message (step e). The home network data identifies the home network 20 to the wireless device 100 and provides information to the wireless device 100 needed for connecting to the home network 20. The home network data may comprise, for example, a network identifier and/or a network address for connecting to the home network 20. In some embodiments, the wireless device 100 may use the network identifier to look up the network address from other sources.

Once the wireless device 100 has the home network data, the wireless device 100 may perform an initial attachment procedure to attach to the home network 20 and download permanent security credentials. During the attachment process, the wireless device sends an activation request including its temporary device identifier to the home network 20 (step f). When the wireless device 100 attaches to the home network 20, the wireless device 100 and home network 20 may execute an Authentication and Key Agreement (AKA) protocol as described in TS 33.102 (step g). As part of the AKA procedure, or simultaneously therewith, the home network 20 sends the key index it received from the registration server 50 to the wireless device 20. The wireless device 100 uses the key index to locate the corresponding key to use for authentication towards the home network 20. Following successful authentication, the home network 20 sends permanent credentials (e.g., USIM) to the wireless device in an activation response message (step h). Once the wireless device 100 has downloaded the permanent security credentials from the home network 20, it may abandon the key used during the initial attach procedure since the key is no longer needed.

In the scenario described above, it is possible for the home network 20 to send an index value other than the one it received from the registration server 50 in an attempt to make the wireless device 100 reveal information about other keys. To avoid this problem, the home network 20 may be required to provide the wireless device 100 with a keyed hash of the index in addition to the key index. The keyed hash comprises a hash of the key index made using the corresponding key provided to the home network 20 by the registration server 50. The wireless device 100 may thus confirm that the home network 20 is in possession of the key by generating a hash of the index received from the home network 20 using the corresponding key stored in its local key table, and comparing the result with the keyed hash received from the home network 20. This additional security measure prevents the home network 20 or fraudulent third party from forging a key index.

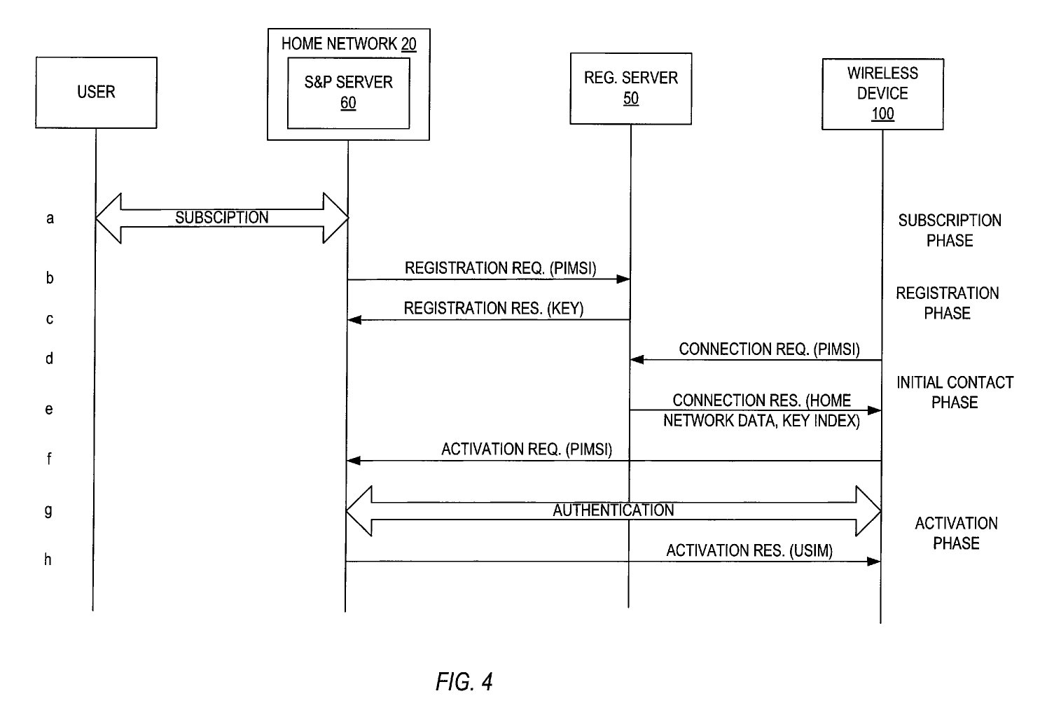

FIG. 4 illustrates a second exemplary method for authentication between the home network 20 and wireless device 100 using the registration server 50 as a trusted agent. As in the previous embodiment, the wireless device 100 is pre-provisioned with a temporary device identifier and a key table is stored by both the registration server 50 and wireless device 100. The device owner subscribes to services of the home network 20 (step a). During the subscription process, the user provides the temporary device identifier to the subscription and provisioning server 60 in the home network 20.

After the subscription is created, the home network 20 uses the temporary device identifier to register itself as the service provider for the wireless device 100. During the registration procedure, the home network 20 sends a registration request message including the temporary device identifier to the registration server 50 (step b). The registration server 50 uses the temporary device identifier to locate the corresponding key table and selects key from the key table. The registration server 50 sends the selected key to the home network 20 in a registration response message (step c).

During the initial contact phase, the wireless device 100 connects to the registration server 50 to obtain the home network data for the home network 20. The wireless device 100 sends a connection request message including its temporary device identifier to the registration server 50 in a connection request (step d). In a connection response message, the registration server 50 provides the matching key index to the wireless device 100, along with the home network data (step e).

In the activation phase, the wireless device 100 sends an activation request including its temporary device identifier to the home network 20 (step f). When the wireless device 100 attaches to the home network 20 to download its permanent security credentials, the wireless device 100 and home network 20 perform an AKA procedure as specified in TS 33.102 (step g). During the AKA procedure, the home network 20 uses the key provided by the registration server 50. The wireless device 100 uses the index provided by the registration server 50 to locate the key to be used, which corresponds to the key that was provided to the home network 20 by the registration server 50. Following successful authentication, the home network 20 sends permanent credentials (e.g., USIM) to the wireless device 100 (step h).

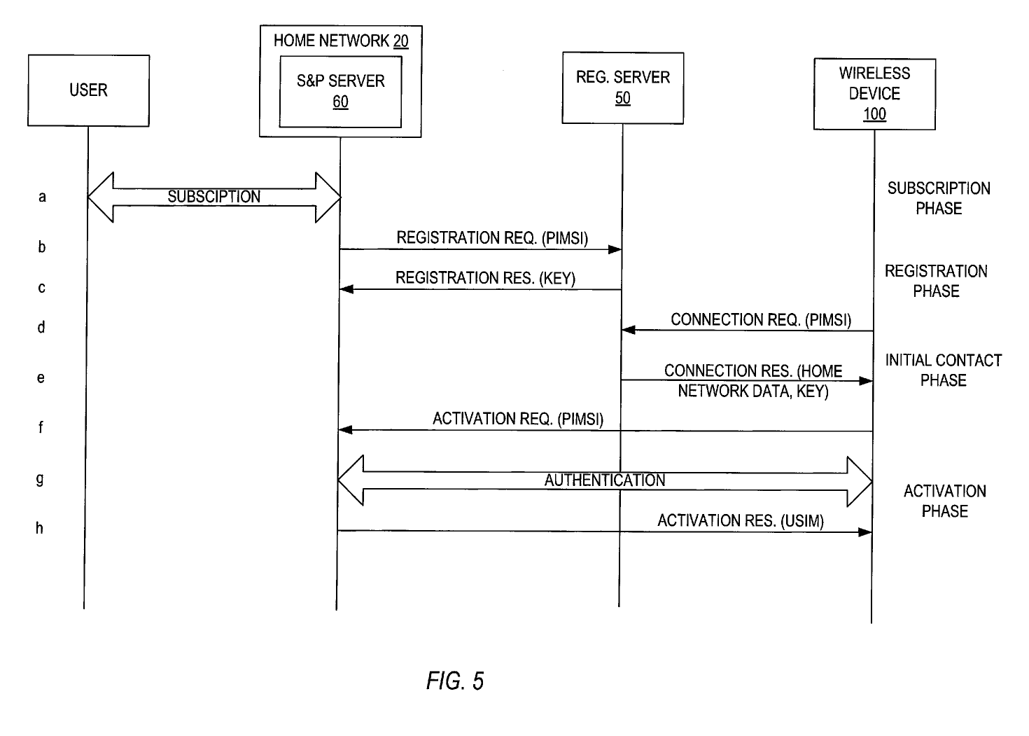

FIG. 5 illustrates a third exemplary method for authentication between a home network 20 and wireless device 100 using the registration server 50 as a trusted agent. Like the previous embodiments, the wireless device 100 is pre-provisioned with a temporary device identifier and provides its temporary device identifier to the home network 20 when it subscribes to the services of the home network 20 (step a). Unlike the previous two embodiments, the wireless device 100 in this exemplary embodiment does not store a key table.

The home network 20 registers as the service provider for the wireless device 100 using the temporary device identifier provided by the wireless device 100. During the registration procedure, the home network 20 sends a registration request message including the temporary device identifier to the registration server 50 (step b). The registration server 50 selects an authentication key and sends the selected authentication key to the home network 20 in a registration response message (step c). The authentication key may be selected from a key table associated with the temporary device identifier. Alternatively, the registration server 50 may allocate an authentication key from a set of keys, or generate the authentication key on the fly.

During the initial contact phase, the wireless device 100 connects to the registration server 50 to obtain the home network data for the home network 20. The wireless device 100 sends a connection request message including its temporary device identifier to the registration server 50 in a connection request (step d). In a connection response message, the registration server 50 provides the authentication key to the wireless device 100, along with the home network data (step e).

In the activation phase, the wireless device 100 sends an activation request including its temporary device identifier to the home network 20 (step f). When the wireless device 100 attaches to the home network 20 to download its permanent security credentials, the wireless device 100 and home network 20 perform an AKA procedure as specified in TS 33.102 (step g). During the AKA procedure, the home network 20 and wireless device 100 use the key provided by the registration server 50 to authenticate each other. Following successful authentication, the home network 20 sends permanent credentials (e.g., USIM) to the wireless device 100 (step h).

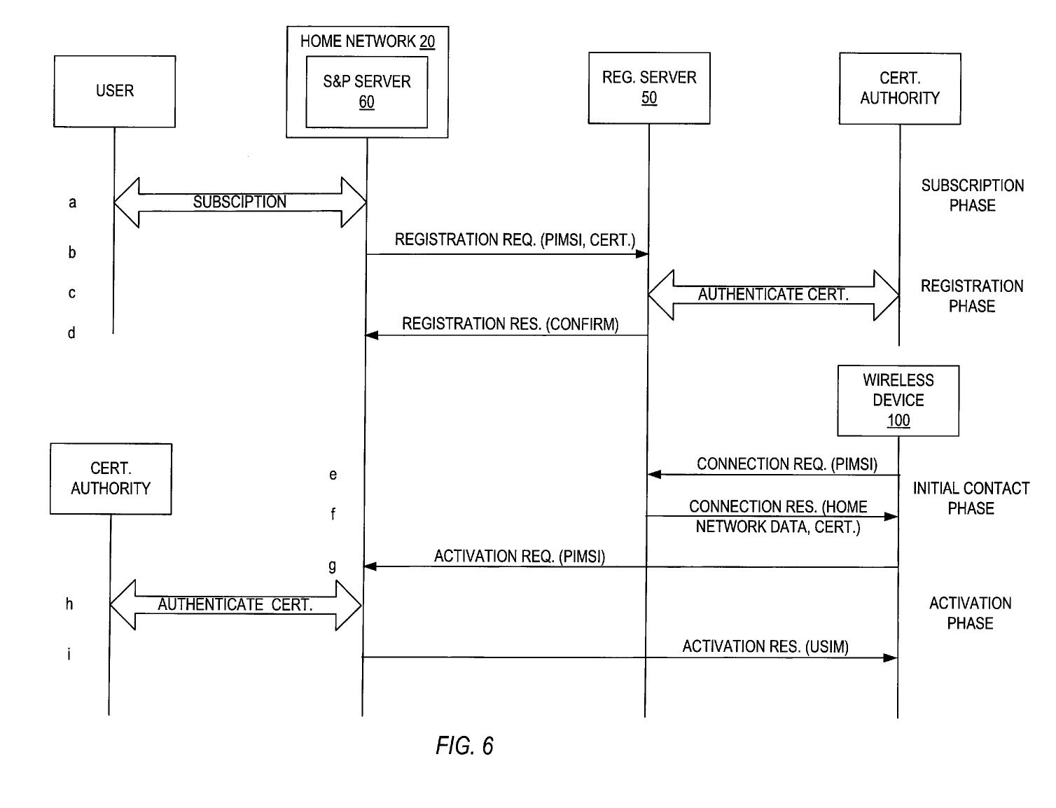

FIG. 6 illustrates a fourth exemplary method for authentication between a home network 20 and a wireless device 100 using the registration server 50 as a trusted agent. The registration server 50, in turn, relies on the services of a certificate authority. The wireless device 100 is pre-provisioned with a temporary device identifier, which it provides to the home network 20 when it subscribes to the services of the home network 20 (step a). The home network 20 registers as the service provider for the wireless device 100. During the registration procedure, the home network 20 sends the temporary device identifier and a home network certificate to the registration server 50 as part of a registration request (step b). The registration server 50 verifies the certificate using the services of the certificate authority and stores the home network certificate (step c). The registration server 50 then sends a registration response message to the home network 20 to confirm successful registration (step d).

During the initial contact phase, the wireless device 100 connects to the registration server 50 to obtain the home network data for the home network 20. The wireless device 100 sends a connection request message including its temporary device identifier to the registration server 50 in a connection request (step e). In a connection response message, the registration server 50 provides the home network certificate to the wireless device 100, along with the home network data (step f). Because the registration server 50 has already verified the certificate, the wireless device 100 does not need to do so.

In the activation phase, the wireless device 100 sends an activation request including its temporary device identifier to the home network 20 (step g). When the wireless device 100 attaches to the home network 20, the wireless device 100 may encrypt the activation request message using the home network certificate and sign the encrypted message with a wireless device certificate. Because the message is encrypted, with the home network certificate, only the home network 20 will be able to decrypt the message. The encrypted message may convey information required to derive a shared key using an algorithm such as the Diffie-Hellman Key Exchange Protocol. When the home network 20 receives the encrypted message from the wireless device 100, the home network 20 may verify the identity of the wireless device 20 by checking the validity of the wireless device certificate using the services of a certificate authority (step h). The certificate authority for verifying the wireless device certificate may be the same as the certificate authority for verifying the home network certificate, or may be a different certificate authority. For example, the certificate authority for verifying the wireless device certificate may be co-located with the registration server 50. Following successful authentication of the wireless device certificate by the home network 20, the home network 20 sends permanent credentials (e.g., USIM) to the wireless device 100 (step i).

In a variation of the embodiment shown in FIG. 6, the wireless device 100 may provide its wireless device certificate to the registration server 50 when it sends the connection request. The registration server 50 may then verify the wireless device certificate and sign the wireless device certificate with the registration server's own certificate. When the registration server 50 returns the home network certificate to the wireless device 100, it may provide the copy of the wireless device certificate signed by the registration server 50. When the wireless device 100 subsequently contacts the home network 20, it provides the home network 20 with the signed copy of the wireless device certificate. The advantage of this variation is that it allows the home network 20 to immediately confirm the identity of the wireless device 100 without the need to contact an external certificate authority because there is a previous trust relationship between the home network 20 and registration server 50 established during the initial registration procedure. Thus, the home network 20 will accept the wireless device certificate signed by the registration server 50. Also, if the certificate authority for verifying the wireless device certificate is controlled by the registration server 50, the process includes fewer agents and is more secure.

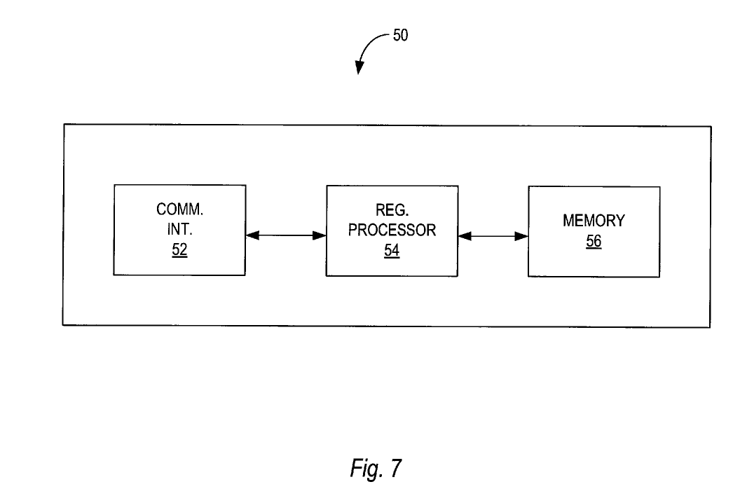

FIG. 7 illustrates an exemplary registration server 50. Registration server 50 comprises a communication interface 52, a registration processor 54, and memory 56. Communication interface 52 connects the registration server 50 to a communication network and enables communication with external devices. Registration processor 54 comprises the logic for performing registration and distributing authentication data as described above. Memory 56 stores computer executable code carrying out the functions of the registration server 50. The memory 56 also stores registration data and authentication data.

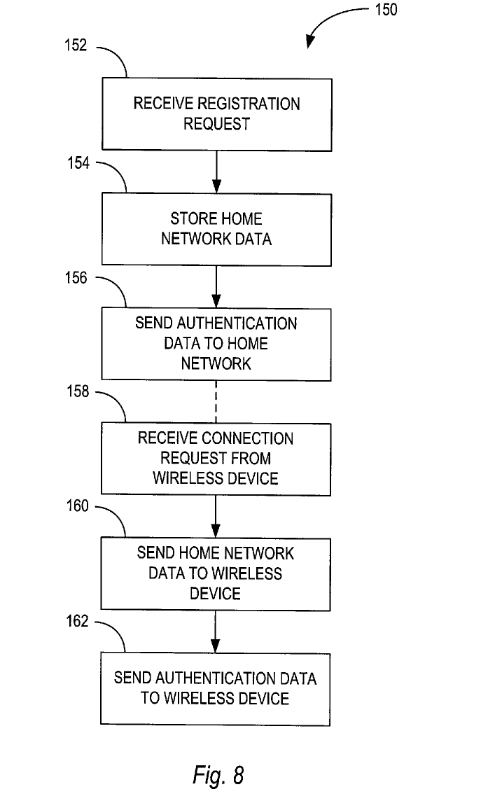

FIG. 8 illustrates an exemplary method 150 implemented by the registration server 50 to facilitate the error provisioning of the wireless device. The method 150 starts when the registration server 50 receives a request from the home network 20 to register as the service provider for the wireless device 100 (block 152). In a preferred embodiment, the registration request includes a temporary device identifier for the wireless device 100 and home network data. The registration server 50 associates the home network data with the temporary device identifier and stores the home network data in memory 56 (block 154). Additionally, the registration server 50 sends the home network 20 authentication data associated with the temporary device identifier (block 156). As described previously, the authentication data is used by the home network 20 for mutual authentication with the wireless device 100. The registration server 50 preferably authenticates the home network operator prior to sending the authentication data. Subsequent to the registration, the registration server 50 receives a connection request including the temporary device identifier from the wireless device 100 (block 158), and sends the wireless device 100 the home network data associated with the temporary device identifier (block 160). In some embodiments, the registration server 50 may also send authentication data to the wireless device 100, which is used by the wireless device 100 to authenticate the home network 20 (block 162). For example, the registration server 50 may send a key index as shown in FIG. 4, an authentication key as shown in FIG. 5, or a home network certificate as shown in FIG. 6. The authentication data is used by the wireless device 100 to authenticate the home network 20.

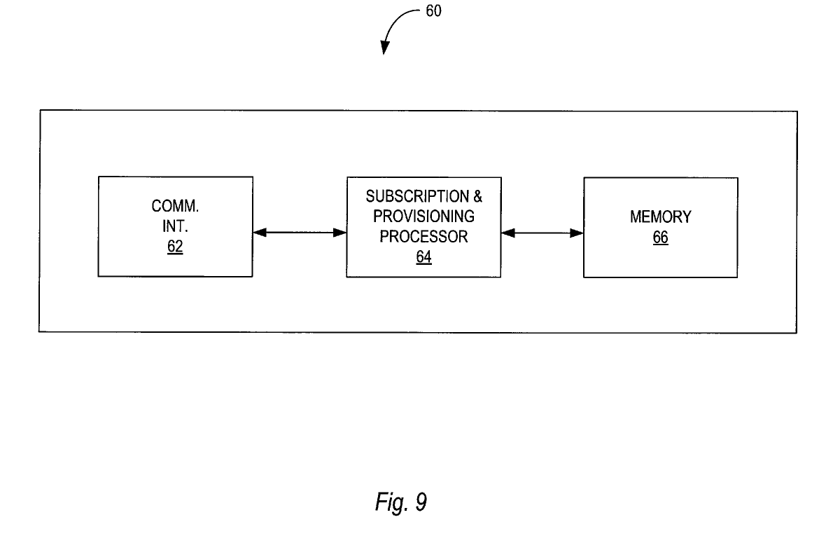

FIG. 9 illustrates an exemplary subscription and provisioning server 60 for the home network 20. The subscription and provisioning server 60 comprises a communication interface 62, subscription processor 64, and memory 66. The communication interface 62 connects the subscription and provisioning server 60 to a communication network, such as the home network 20 or PDN 40, and enables the subscription and provisioning server 60 to communicate with external devices. The functions of the subscription and provisioning server 60 are to create subscriptions for wireless devices 100, register the subscriptions with the registration server 50, and provide permanent security credentials to the wireless devices 100. These functions are performed by the subscription and provisioning processor 64. Memory 66 stores computer executable code executed by the subscription and provisioning processor 64, as well as other data needed for operation.

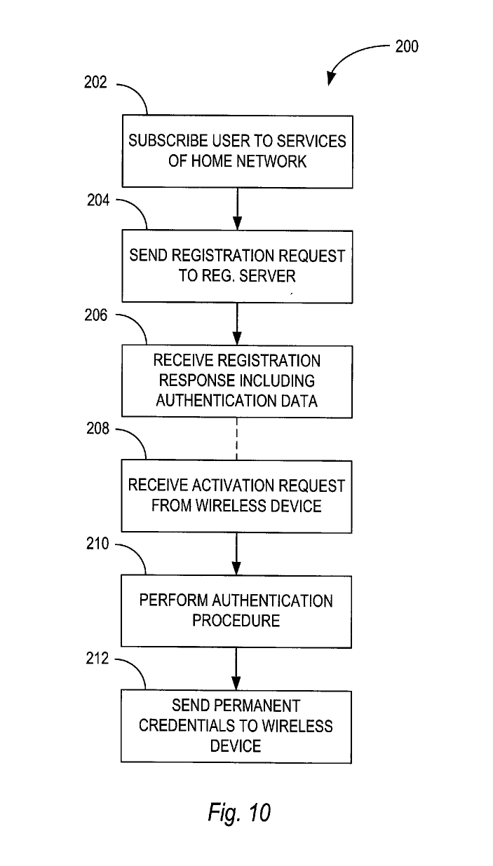

FIG. 10 illustrates an exemplary method 200 implemented by the subscription and provisioning server 60. The process 200 begins when a user contacts the subscription server 60 to subscribe to the services of the home network 20. The subscription and provisioning server 60 may provide a website accessible to device owners for subscribing to the services of the home network 20. During the subscription process, the device owner provides the subscription and provisioning server 60 with the temporary device identifier for the wireless device 100. The subscription and provisioning server 60 subscribes the wireless device 100 (block 202) and sends a registration message including the temporary device identifier provided by the device owner to the registration server 50 to register as the service provider for the wireless device 100 (block 204). In response to the registration request, the subscription and provisioning server 60 receives authentication data from the registration server 50 for performing mutual authentication with the wireless device 100 (block 206). When the subscription and provisioning server 60 subsequently receives an activation request from the wireless device 100 (block 208), the subscription and provisioning server 60 performs authentication with the wireless device 100 (block 210). If the authentication procedure is successful, the subscription and provisioning sever 60 sends permanent security credentials to the wireless device 100 to activate the wireless device 100 (block 212).

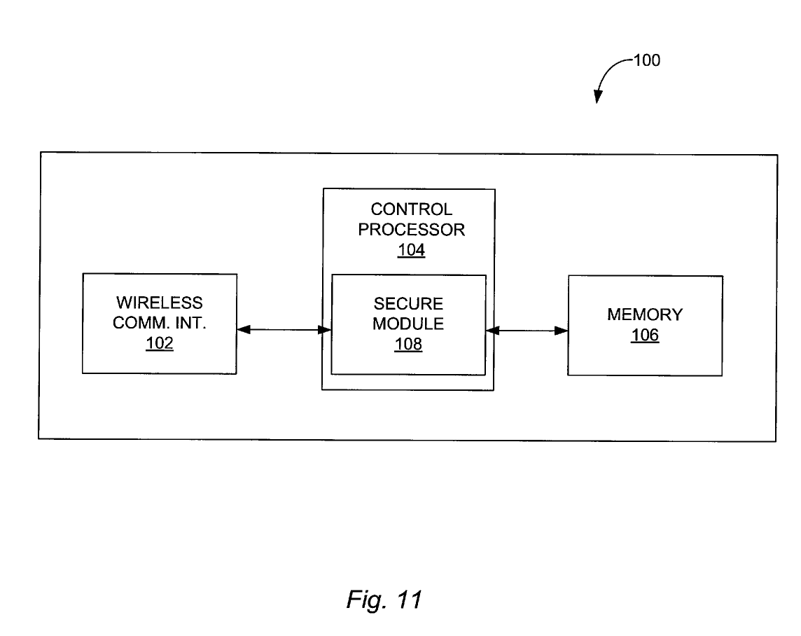

FIG. 11 illustrates an exemplary wireless device 100. The wireless device 100 may, for example, comprise an M2M device, cellular phone, or other wireless device. Wireless device 100 includes a wireless communication interface 102, control processor 104, and memory 106. Those skilled in the art will appreciate that the wireless device 100 includes additional elements not shown in the drawings, which are not essential to understanding the present invention. Such additional elements include, for example, a display, keypad, speakers, microphone, etc. The wireless communication interface 102 enables the wireless device 100 to communicate with wireless networks, such as the home network 20, and initial connectivity network 30. The wireless communication interface 102 may also enable the wireless device 100 to communicate with a wireless access point connected to the PDN 40. The control processor 104 is configured to implement the activation procedure described above according to computer executable code stored in memory 106. Control processor 104 preferably includes a secure module 108 that provides a secure, tamper-proof environment for storage of security credentials and execution of security functions.

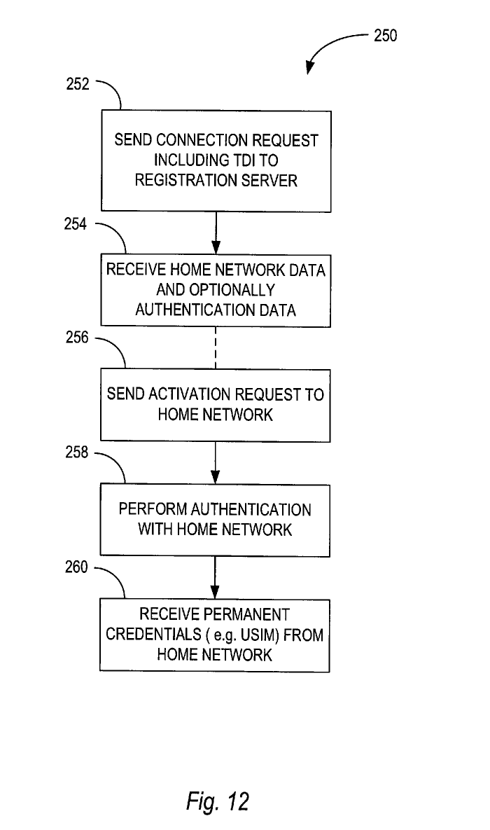

FIG. 12 illustrates an exemplary method 250 implemented by the control processor 104 for activating the wireless device 100. The wireless device 100 initially connects to the registration server 50 through the initial connectivity network 30 and sends its temporary device identifier to the registration server 50 (block 252). In reply to the connection request, the wireless device 100 receives home network data identifying the home network 20 from the registration server 50 (block 254). In some embodiments, the wireless device 100 may also receive authentication data. The wireless device 100 uses the home network data to connect to the home network 20 and send an activation request including its temporary device identifier (block 256). During the initial connection to the home network 20, the wireless device 100 may use the authentication data provided by the registration server 50 to execute an authentication procedure with the home network 20 that allows the wireless device 100 and home network 20 to authenticate one another (block 258). Following the authentication procedure, the wireless device 100 downloads permanent security credentials from the home network 20 (block 260).

The present invention provides a secure method enables the owner of the wireless device to purchase a subscription from a home operator chosen by the owner, and to download a USIM from the home operator. The present invention may, of course, be carried out in other ways than those specifically set forth herein without departing from essential characteristics of the invention. The present embodiments are to be considered in all respects as illustrative and not restrictive, and all changes coming within the meaning and equivalency range of the appended claims are intended to be embraced therein.

What is claimed is:

1. A method implemented by a registration server of providing authentication data to a wireless device for over-the-air provisioning of the wireless device, said method comprising:
receiving a registration request including a temporary device identifier for the wireless device from a home network;
associating home network data for the home network with the temporary device identifier and storing the home network data;
sending the home network first authentication data associated with the temporary device identifier for authenticating the home network to the wireless device during device activation;
receiving a connection request including the temporary device identifier from the wireless device; and
sending the wireless device the stored home network data associated with the temporary device identifier.

2. The method of claim 1 further comprising:
storing a key table associated with the temporary device identifier in memory, said key table comprising a plurality of key pairs including a key and a corresponding key index; and
selecting a key pair from said key table for use in authenticating the home network to the wireless device.

3. The method of claim 2 wherein sending the home network first authentication data comprises sending the home network at least one of the key and corresponding key index from the selected key pair.

4. The method of claim 3 wherein sending the home network first authentication data comprises sending the home network both the key and corresponding key index from the selected key pair.

5. The method of claim 4 further comprising sending the wireless device at least one of the key and corresponding key index from the selected key pair.

6. The method of claim 4 further comprising sending the wireless device only the key index from the selected key pair.

7. The method of claim 2 wherein sending the home network first authentication data comprises sending the home network the key from a selected key pair.

8. The method of claim 7 further comprising sending the wireless device the key index from the selected key pair.

9. The method of claim 1 wherein sending the home network first authentication data comprises sending an authentication key to said home network.

10. The method of claim 9 wherein sending the wireless device second authentication data comprises sending the wireless device the authentication key provided to the home network.

11. A registration server for providing authentication data to a wireless device for over-the-air provisioning of the wireless device, said registration server comprising:
a communication interface for communicating over a communication network with a wireless device and a home network for the wireless device;
memory for storing registration information for said wireless device; and
a registration processor connected to the communication interface and the memory, said registration processor being configured to:
receive a registration request including a temporary device identifier for the wireless device from a home network;
associate home network data for the home network with the temporary device identifier and store the home network data in memory;
send the home network first authentication data associated with the temporary device identifier for authenticating the home network to the wireless device during device activation;
receive a connection request including the temporary device identifier from the wireless device; and
send the wireless device the stored home network data associated with the temporary device identifier.

12. The registration server of claim 11 wherein said memory stores a key table associated with the temporary device identifier, said key table comprising a plurality of key pairs including a key and a corresponding key index; and wherein said registration processor is further configured to select a key pair from said key table for use in authenticating the home network to the wireless device.

13. The registration server of claim 12 wherein sending the home network first authentication data comprises sending the home network at least one of the key and corresponding key index from the selected key pair.

14. The registration server of claim 13 wherein the registration processor is further configured to send the home network both the key and corresponding key index from the selected key pair as the first authentication data.

15. The registration server of claim 14 wherein the registration processor is further configured to send the wireless device at least one of the key and corresponding key index from the selected key pair as second authentication data.

16. The registration server of claim 15 wherein the registration processor is further configured to send the wireless device only the key index from the selected key pair as second authentication data.

17. The registration server of claim 12 wherein the registration processor is further configured to send the home network only the key from a selected key pair as the first authentication data.

18. The registration server of claim 17 wherein the registration processor is further configured to send the wireless device the key index from the selected key pair as the first authentication data.

19. The registration server of claim 11 wherein the registration processor is further configured to send the home network an authentication key as the first authentication data.

20. The registration server of claim 19 wherein the registration processor is further configured to send the wireless device the authentication key provided to the home network as second authentication data.

21. A method implemented by a home network for activating a wireless device subscribing to the services of the home network, said method comprising:
subscribing the wireless device to services of the home network and receiving a temporary device identifier from the wireless device user during a subscription process;
sending a registration request including the temporary device identifier for the wireless device to a registration server to register as the service provider for the wireless device;
receiving authentication data associated with the temporary device identifier from the registration server;
receiving an activation request including the temporary device identifier from the wireless device;
authenticating the home network to the wireless device using the authentication data provided by the registration server; and
sending permanent security credentials to the wireless device to activate the wireless device.

22. The method of claim 21 wherein the authentication data comprises at least one of an authentication key and a corresponding key index selected from a key table associated with the temporary identifier.

23. The method of claim 22 wherein the authentication data comprises both the key and the corresponding key index selected from the key table.

24. The method of claim 23 wherein authenticating the home network to the wireless device using the authentication data provided by the registration server comprises sending a keyed hash of the key index to the wireless device to prove possession of both the key and the key index.

25. The method of claim 21 wherein the authentication data comprises an authentication key associated with the temporary device identifier for the wireless device.

26. The method of claim 21 further comprising authenticating the wireless device using the authentication data prior to sending permanent credentials to the wireless device.

27. A subscription system in a home network for provisioning a wireless device with permanent security credentials, said subscription system comprising:
a communication interface for communicating over a communication network with a wireless device and a registration server; and
a subscription processor connected to the communication interface and configured to:
subscribe the wireless device to services of the home network during a subscription process;
receive a temporary device identifier from the wireless device during the subscription process;
send a registration request including the temporary device identifier for the wireless device to the registration server to register a subscription for the wireless device with the registration server;
receive authentication data associated with the temporary device identifier from the registration server;
receive an activation request including the temporary device identifier from the wireless device;
authenticate the home network to the wireless device using the authentication data provided by the registration server; and
send permanent credentials to the wireless device to activate the home device.

28. The subscription system of claim 27 wherein the authentication data received by the subscription processor comprises at least one of an authentication key and a corresponding key index selected from a key table associated with the temporary identifier.

29. The subscription system of claim 28 wherein the authentication data received by the subscription processor comprises both the key and the corresponding key index selected from the key table.

30. The subscription system of claim 29 wherein the subscription processor authenticates the home network to the wireless device by sending a keyed hash of the key index to the wireless device to prove possession of both the key and the key index.

31. The subscription system of claim 27 wherein the authentication data received by the subscription processor comprises a shared authentication key associated with the temporary device identifier for the wireless device.

32. The subscription system of claim 27 wherein the subscription processor is further configured to authenticate the wireless device using the authentication data prior to sending permanent credentials to the wireless device.

33. A method implemented by a wireless device for activating the wireless device to receive services from a selected home network, said method comprising:
sending a connection request including a temporary device identifier to a registration server;
receiving home network data identifying the home network from the registration server responsive to the connection request;
connecting to the home network;
receiving from the home network an authentication message generated using first authentication data provided to the home network by the registration server;
authenticating the home network based on first authentication data; and
downloading permanent subscription credentials from the home network.

34. The method of claim 33 further comprising storing a key table in memory, said key table comprising a plurality of key pairs including a key and a corresponding key index, and wherein the first authentication data comprises at least one of a key and corresponding key index selected from the key table.

35. The method of claim 34 wherein authenticating the home network comprises verifying the authentication message using at least one of a key or key index selected from the key table stored in memory.

36. The method of claim 35 further comprising receiving second authentication data from the registration server corresponding to the first authentication data, and wherein verifying the authentication message comprises using the second authentication data to prove possession by the home network of a valid key in the key table.

37. The method of claim 33 wherein authenticating the home network comprises receiving an authentication message incorporating the first authentication data from the home network during device activation and verifying the authentication message received from the home network based on second authentication data received by the wireless device from the registration server.

38. The method of claim 33 wherein the first and second authentication data comprises a shared authentication key provided to the wireless device and the home network by the registration server.

39. A wireless device comprising:
a communication circuit for communicating with a home network and a registration server over a wireless communication network; and
a control processor connected to the communication circuit configured to:
send a connection request including a temporary device identifier to the registration server;
receive home network data identifying the home network from the registration server;
receive from the home network an authentication message generated using first authentication data provided to the home network by the registration server;
authenticate the home network based on the first authentication data; and
download permanent subscription credentials from the home network.

40. The wireless device of claim 39 further comprising memory for storing a key table, said key table comprising a plurality of key pairs including a key and a corresponding key index, and wherein the first authentication data comprises at least one of a key and corresponding key index selected from the key table.

41. The wireless device of claim 40 wherein the control processor is configured to verify the first authentication message received from the home network using at least one of a key or key index selected from the key table stored in memory.

42. The wireless device of claim 41 wherein the control processor is further configured to receive second authentication data from the registration server corresponding to the first authentication data, and to verify the authentication message received from the home network using the second authentication data to prove possession by the home network of a valid key in the key table.

43. The wireless device of claim 39 wherein the control processor is further configured to receive an authentication message incorporating the first authentication data from the home network during device activation and to verify the authentication message received from the home network based on second authentication data received by the wireless device from the registration server.

44. The wireless device of claim 43 wherein the first and second authentication data comprises a shared authentication key provided to the wireless device and the home network by the registration server, and wherein the control processor is configured to authenticate the home network using the shared authentication key.
